(19) United States
(12) Patent Application Publication
(10) Pub. No.: US 2016/0230693 A1
(43) Pub. Date: Aug. 11, 2016

(54) VEHICLE

(71) Applicant: Toyota Jidosha Kabushiki Kaisha, Toyota-shi (JP)

(72) Inventor: Kazuya Miyaji, Okazaki-shi (JP)

(21) Appl. No.: 15/010,934

(22) Filed: Jan. 29, 2016

(30) Foreign Application Priority Data
Feb. 10, 2015 (JP) 2015-024288

(51) Int. Cl. F02D 41/34

(52) U.S. Cl. CPC F02D 41/34

(57) ABSTRACT

A vehicle includes a port injection valve injecting fuel supplied from a feed pump to engine, and a low-pressure fuel pressure sensor detecting fuel pressure P generated by the feed pump. When a fault diagnosis of the low-pressure fuel pressure sensor is to be conducted, an engine ECU increases fuel pressure P to a diagnosis pressure P2 higher than a normal control pressure P1. Based on whether the output of the low-pressure fuel pressure sensor at this time is a value representing diagnosis pressure P2, the engine ECU determines whether the low-pressure fuel pressure sensor has a fault. In the case where the increase of fuel pressure P to diagnosis pressure P2 has caused excessive fuel (rich air-fuel ratio), the engine ECU changes the engine operating point so that the rotational speed of the engine is decreased while keeping the engine output in order to increase the load ratio.

### CROSS-REFERENCE TO RELATED APPLICATIONS

This nonprovisional application claims the benefit of Japanese Patent Application No. 2015-024288 filed on Feb. 10, 2015 with the Japan Patent Office, the entire contents of which are hereby incorporated by reference.

### BACKGROUND

1. Field

The present disclosure relates to a vehicle including a fuel pump, an injection valve injecting fuel supplied from the fuel pump to an engine, and a fuel pressure sensor detecting a supply pressure of the fuel generated by the fuel pump.

2. Description of the Background Art

Japanese Patent Laying-Open No. 2013-68127 discloses that a fault diagnosis of a fuel pressure sensor is conducted for a vehicle which includes a fuel pump, an injection valve injecting fuel supplied from the fuel pump to an engine, and the fuel pressure sensor detecting a supply pressure of the fuel generated by the fuel pump. For the fault diagnosis of the fuel pressure sensor, the fuel pressure is increased to a diagnosis fuel pressure higher than a fuel pressure for normal use. Based on whether or not an output of the fuel pressure sensor at this time is a value representing the diagnosis fuel pressure, it is determined whether or not the fuel pressure sensor has a fault.

### SUMMARY

However, regarding the vehicle disclosed in Japanese Patent Laying-Open No. 2013-68127, if a fault diagnosis of the fuel pressure sensor is conducted under the condition for example that the engine load ratio (the ratio of the intake air quantity to the quantity of drawable air) is low, the fuel pressure which is increased to the diagnosis fuel pressure in spite of the low load ratio (small intake air quantity) could cause excessive fuel (rich air-fuel ratio), and accordingly cause deterioration of the emission performance.

Some embodiments described herein conduct a fault diagnosis of a fuel pressure sensor without deteriorating the emission performance.

A vehicle according to the present disclosure includes: an engine; a fuel pump; an injection valve configured to inject fuel supplied from the fuel pump to the engine; a fuel pressure sensor configured to detect a supply pressure of the fuel generated by the fuel pump; and a control apparatus configured to perform a fuel pressure increasing process of increasing the supply pressure of the fuel generated by the fuel pump to a second fuel pressure higher than a first fuel pressure, and conduct a fault diagnosis of the fuel pressure sensor based on a value detected by the fuel pressure sensor during the fuel pressure increasing process. In a case where a fuel injection quantity of the injection valve becomes excessive with respect to a load ratio of the engine during the fuel pressure increasing process, the control apparatus performs a load ratio increasing process of changing an operating point of the engine so that the load ratio of the engine increases.

With such a configuration, in the case where the fuel pressure increasing process performed when a fault diagnosis of the fuel pressure sensor is conducted causes the fuel injection quantity to become excessive with respect to the engine load ratio, the load ratio increasing process is performed to increase the engine load ratio. Accordingly, the intake air quantity is increased and thus excessive fuel (rich air-fuel ratio) is prevented. As a result, a fault diagnosis of the fuel sensor can be conducted without deteriorating the emission performance.

In some embodiments, the load ratio increasing process is a process of increasing the load ratio of the engine by decreasing a rotational speed of the engine while keeping an output of the engine as it is.

With such a configuration, the load ratio increasing process can be performed to increase the engine load ratio while keeping the engine output as it is.

In some embodiments, the fuel injection quantity of the injection valve is proportional to a product of the supply pressure of the fuel generated by the fuel pump and an injection time of the injection valve. A control range of the injection time of the injection valve is limited to a minimum injection time or more. In the case where a target fuel injection quantity determined by an intake air quantity and a target air-fuel ratio is less than a minimum injection quantity determined by the second fuel pressure and the minimum injection time, the control apparatus determines that the fuel injection quantity of the injection valve is excessive with respect to the load ratio of the engine and performs the load ratio increasing process.

With such a configuration, even when the injection time of the injection valve is limited to a minimum injection time or more, a fault diagnosis of the fuel pressure sensor can be conducted without deteriorating the emission performance.

In some embodiments, the control apparatus continues the load ratio increasing process until the target fuel injection quantity becomes larger than the minimum injection quantity.

With such a configuration, the load ratio increasing process can be performed to ensure that the target fuel injection quantity is made larger than the minimum injection quantity.

In some embodiments, the first fuel pressure is a control fuel pressure used when a fault diagnosis of the fuel pressure sensor is not conducted. The second fuel pressure is a diagnosis fuel pressure used when a fault diagnosis of the fuel pressure sensor is conducted.

With such a configuration, even when the fuel pressure is increased to the diagnosis fuel pressure which is not used under normal control, deterioration of the emission performance can be prevented.

In some embodiments, the injection valve is a port injection valve injecting fuel to an intake passage of the engine.

With such a configuration, a fault diagnosis of the fuel pressure sensor detecting the fuel pressure of the port injection valve can be conducted without deteriorating the emission performance.

The foregoing and other objects, features, aspects and advantages of the present disclosure will become more apparent from the following detailed description when taken in conjunction with the accompanying drawings.

### BRIEF DESCRIPTION OF THE DRAWINGS

FIG. 1 is a block diagram showing a configuration of a vehicle.

FIG. 2 is a diagram showing a configuration of an engine and a fuel supply apparatus.

FIG. 3 is a diagram showing injection characteristics of a port injection valve.

FIG. 4 is a diagram showing a correlation between fuel pressure P and output voltage V of a low-pressure fuel pressure sensor in the case where the low-pressure fuel pressure sensor is in a normal condition.

FIG. 5 is a diagram showing a relation between fuel pressure P, injection time T, and fuel injection quantity Q.

FIG. 6 is a diagram for illustrating details of an engine load ratio increasing process.

FIG. 7 is a flowchart showing a process procedure in the case where an engine ECU conducts a fault diagnosis of a low-pressure fuel pressure sensor.

### DETAILED DESCRIPTION

Embodiments of the present disclosure will hereinafter be described in detail with reference to the drawings. In the drawings, the same or corresponding parts are denoted by the same reference characters, and a description thereof will not be repeated.

[Basic Configuration of Vehicle]

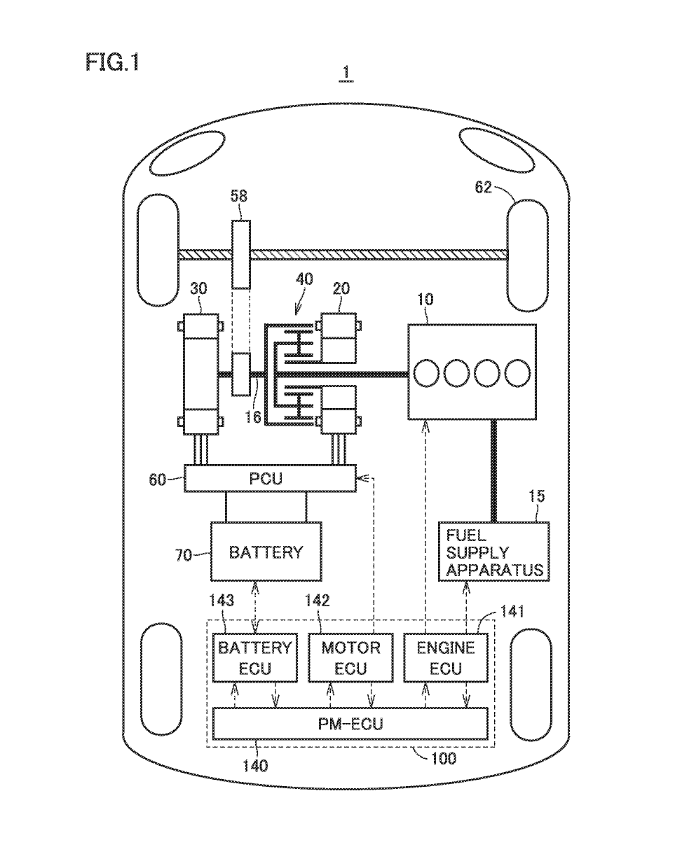

FIG. 1 is a block diagram showing a configuration of a vehicle 1. Referring to FIG. 1, vehicle 1 includes an engine 10, a fuel supply apparatus 15, motor generators 20, 30, a power split device 40, a reduction mechanism 58, drive wheels 62, a power control unit (PCU) 60, a battery 70, and a control apparatus 100.

This vehicle 1 is a series-parallel-type hybrid vehicle and configured to travel with at least one of engine 10 and motor generator 30 acting as a driving source.

Engine 10, motor generator 20, and motor generator 30 are coupled to each other via power split device 40. To a rotational shaft 16 of motor generator 30 which is coupled to power split device 40, reduction mechanism 58 is connected. Rotational shaft 16 is coupled via reduction mechanism 58 to drive wheels 62 and also coupled via power split device 40 to a crankshaft of engine 10.

Power split device 40 is a planetary gear train including a sun gear, a pinion gear, a carrier, and a ring gear. The pinion gear meshes with the sun gear and the ring gear. The carrier supports the pinion gear so that the pinion gear can rotate about its axis, and is coupled to engine 10. The sun gear is coupled to motor generator 20. The ring gear is coupled via rotational shaft 16 to motor generator 30 and drive wheels 62.

Power split device 40 has a characteristic that the rotational speed of the sun gear, the rotational speed of the carrier, and the rotational speed of the ring gear have a relation therebetween represented by a straight line connecting these rotational speeds together in a nomographic chart (a relation that in the case where two of respective values of the rotational speeds are determined, the remaining value is accordingly determined). Therefore, an appropriate adjustment of the rotational speed of motor generator 20 which is coupled to the sun gear allows power split device 40 to function as an electrical continuously-variable transmission capable of continuously varying the ratio between the rotational speed (namely vehicle speed) of drive wheels 62 coupled to the ring gear and the rotational speed of engine 10 coupled to the carrier.

While the present embodiment will be described regarding the case where the present disclosure is applied to a hybrid vehicle including power split device 40 (electrical continuously-variable transmission), the vehicle to which the present disclosure is applicable may be any vehicle having a structure capable of adjusting the engine rotational speed regardless of the vehicle speed. For example, the present disclosure is also applicable to a vehicle including a mechanical continuously-variable transmission between the engine and the drive wheels, for example.

Motor generators 20 and 30 are both a well-known synchronous generator motor which can operate as either a generator or a motor. Motor generators 20 and 30 are connected to PCU 60, and PCU 60 is connected to battery 70.

Control apparatus 100 includes a power management electronic control unit (hereinafter PM-ECU) 140, an engine electronic control unit (hereinafter engine ECU) 141, a motor electronic control unit (hereinafter motor ECU) 142, and a battery electronic control unit (hereinafter battery ECU) 143.

PM-ECU 140 is connected via a communication port (not shown) to engine ECU 141, motor ECU 142, and battery ECU 143. PM-ECU 140 communicates a variety of control signals and data with engine ECU 141, motor ECU 142, and battery ECU 143.

Motor ECU 142 is connected to PCU 60 and controls driving of motor generators 20 and 30. Battery ECU 143 calculates the remaining capacity (hereinafter SOC (State Of Charge)) of battery 70, based on the integral value of the charging/discharging current of battery 70.

Engine ECU 141 is connected to engine 10 and fuel supply apparatus 15. Engine ECU 141 receives signals from a variety of sensors detecting the operating condition of engine 10 (such as accelerator pedal position sensor, throttle opening position sensor, engine rotational speed sensor, engine water temperature sensor, and air-fuel ratio sensor), and performs operational control such as fuel injection control, ignition control, and intake air quantity control.

For example, engine ECU 141 controls the throttle opening position (intake air quantity) based on the vehicle speed and the accelerator pedal position, for example. Engine ECU 141 also performs feedback control for the fuel injection quantity so that the air-fuel ratio detected by an air-fuel ratio sensor (not shown) provided on an exhaust passage becomes a target air-fuel ratio (stoichiometric air-fuel ratio, for example). For example, in the case where the intake air quantity increases to cause the air-fuel ratio to have a value of a lean air-fuel ratio, with respect to the target air-fuel ratio, engine ECU 141 increases the fuel injection quantity so that the air-fuel ratio becomes closer to the target air-fuel ratio.

[Configuration Involved in Fuel Supply]

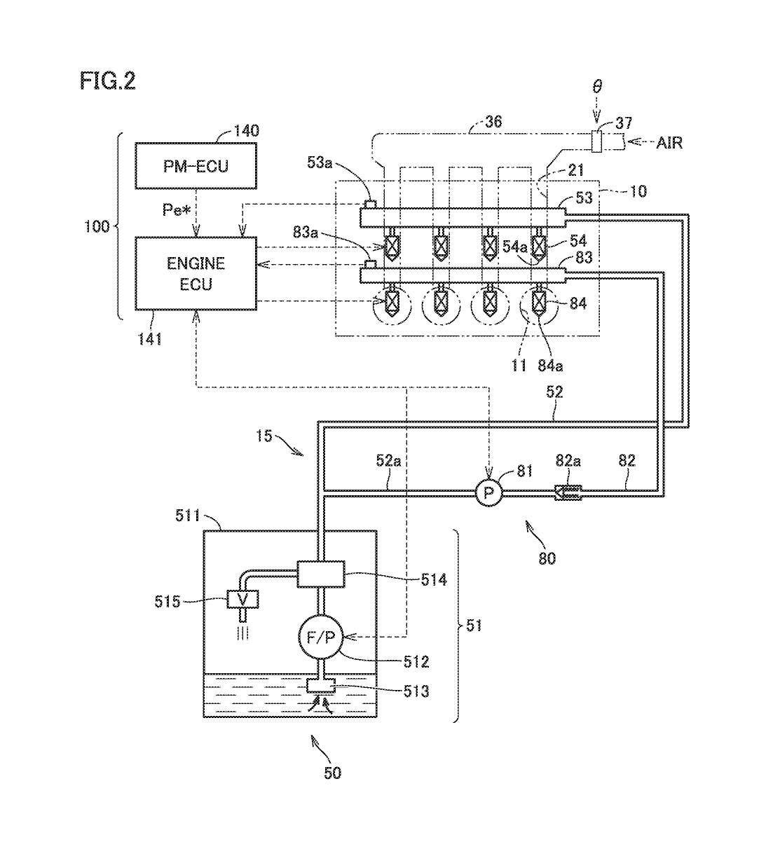

FIG. 2 is a diagram showing a configuration of engine 10 and fuel supply apparatus 15 involved in fuel supply. In the present embodiment, a vehicle to which the present disclosure is applied is a hybrid vehicle in which a dual-injection-type internal combustion engine using in-cylinder injection and port injection in combination, such as for example a four-series-cylinder gasoline engine, is adopted as an internal combustion engine.

Referring to FIG. 2, engine 10 includes an intake manifold 36, a throttle valve 37, an intake port 21, and four cylinders 11 provided in a cylinder block.

In an intake stroke of each cylinder 11, intake air AIR is drawn from an intake pipe into each cylinder 11 through intake manifold 36 and intake port 21.

The quantity of air drawn into each cylinder 11 (intake air quantity) is adjusted based on the opening position (throttle opening position θ) of throttle valve 37. Throttle opening position θ is controlled based on a control signal from engine ECU 141. In the following description, the ratio of the intake air quantity to the quantity of air which can be drawn into each cylinder 11 (quantity of drawable air) is referred to as “engine load ratio.”

Fuel supply apparatus 15 includes a low-pressure fuel supply mechanism 50 and a high-pressure fuel supply mechanism 80. Low-pressure fuel supply mechanism 50 includes a fuel delivery unit 51, a low-pressure fuel pipe 52, a low-pressure delivery pipe 53, a low-pressure fuel pressure sensor 53a, and a port injection valve 54.

High-pressure fuel supply mechanism 80 includes a high-pressure pump 81, a check valve 82a, a high-pressure fuel pipe 82, a high-pressure delivery pipe 83, a high-pressure fuel pressure sensor 83a, and an in-cylinder injection valve 84.

In-cylinder injection valve 84 is an injector for in-cylinder injection having an injection hole portion 84a exposed in a combustion chamber of each cylinder 11. When in-cylinder injection valve 84 is opened, compressed fuel in high-pressure delivery pipe 83 is injected into combustion chamber from injection hole portion 84a of in-cylinder injection valve 84.

Engine ECU 141 is configured to include a CPU (Central Processing Unit), a ROM (Read Only Memory), a RAM (Random Access Memory), an input interface circuit, and an output interface circuit, for example. Engine ECU 141 receives an engine start/stop command from the PM-ECU in FIG. 1, and accordingly controls engine 10 and fuel supply apparatus 15.

Engine ECU 141 calculates a necessary fuel injection quantity for each combustion, based on the accelerator pedal position, the intake air quantity (throttle opening position θ), the engine rotational speed, and the air-fuel ratio, for example. Based on the calculated fuel injection quantity, engine ECU 141 outputs, at an appropriate time, an injection command signal for example to port injection valve 54 and in-cylinder injection valve 84.

While the present embodiment is described regarding the case where low-pressure fuel supply mechanism 50 and high-pressure fuel supply mechanism 80 are provided, the present disclosure is also applicable to a configuration where high-pressure fuel supply mechanism 80 is not provided but low-pressure fuel supply mechanism 50 is provided.

In the following, low-pressure fuel supply mechanism 50 will be described in more detail. Fuel delivery unit 51 includes a fuel tank 511, a feed pump 512, a suction filter 513, a fuel filter 514, and a relief valve 515.

Fuel tank 511 stores fuel, such as gasoline for example, to be consumed by engine 10. Suction filter 513 prevents foreign matter from being sucked in. Fuel filter 514 removes foreign matter in discharge fuel.

Relief valve 515 is opened when the pressure of fuel discharged from feed pump 512 reaches an upper limit pressure, and is kept closed while the fuel pressure is less than the upper limit pressure.

Low-pressure fuel pipe 52 connects fuel delivery unit 51 to low-pressure delivery pipe 53. It should be noted that low-pressure fuel pipe 52 is not limited to the fuel pipe, and may be one member through which a fuel passage is formed, or a plurality of members between which a fuel passage is formed.

Low-pressure delivery pipe 53 is connected, at one end along the direction in which cylinders 11 are arranged in series, to low-pressure fuel pipe 52. To low-pressure delivery pipe 53, port injection valve 54 is coupled. To low-pressure delivery pipe 53, a low-pressure fuel pressure sensor 53a detecting the inside fuel pressure is attached.

Port injection valve 54 is an injector for port injection having an injection hole portion 54a exposed in intake port 21 which is associated with each cylinder 11. Port injection valve 54 is a needle valve which is opened upon being energized through a control signal from engine ECU 141. When port injection valve 54 is opened, the fuel compressed by feed pump 512 and present in low-pressure delivery pipe 53 is injected from injection hole portion 54a into intake port 21.

Based on a command signal transmitted from engine ECU 141, feed pump 512 is driven and stopped.

Feed pump 512 can draw fuel from inside fuel tank 511, compress the drawn fuel, and then discharge the fuel. Further, under control by engine ECU 141, feed pump 512 can change the discharge quantity per unit time [m³/sec] and the discharge pressure [kPa: kilopascal].

The fact that feed pump 512 is controlled in this way may provide a number of benefits. First of all, in order to prevent the inside fuel from vaporizing when the engine temperature becomes a high temperature, it is necessary to apply a pressure to low-pressure delivery pipe 53 to the extent that does not cause vaporization of the fuel. However, if the applied pressure is too high, a high load is exerted on the pump and thus the energy loss is large. Because the pressure applied for preventing vaporization of the fuel varies depending on the temperature, a minimal pressure can be applied to low-pressure delivery pipe 53 to thereby reduce the energy loss. Further, feed pump 512 can be appropriately controlled so that a quantity of fuel corresponding to the quantity of fuel consumed by the engine is discharged, to thereby save the uselessly applied energy. This is therefore advantageous in term of improvement of fuel economy, as compared with the configuration where the pressure is once applied more than necessary and then a pressure regulator is used to make the pressure constant.

[Injection Characteristics of Port Injection Valve]

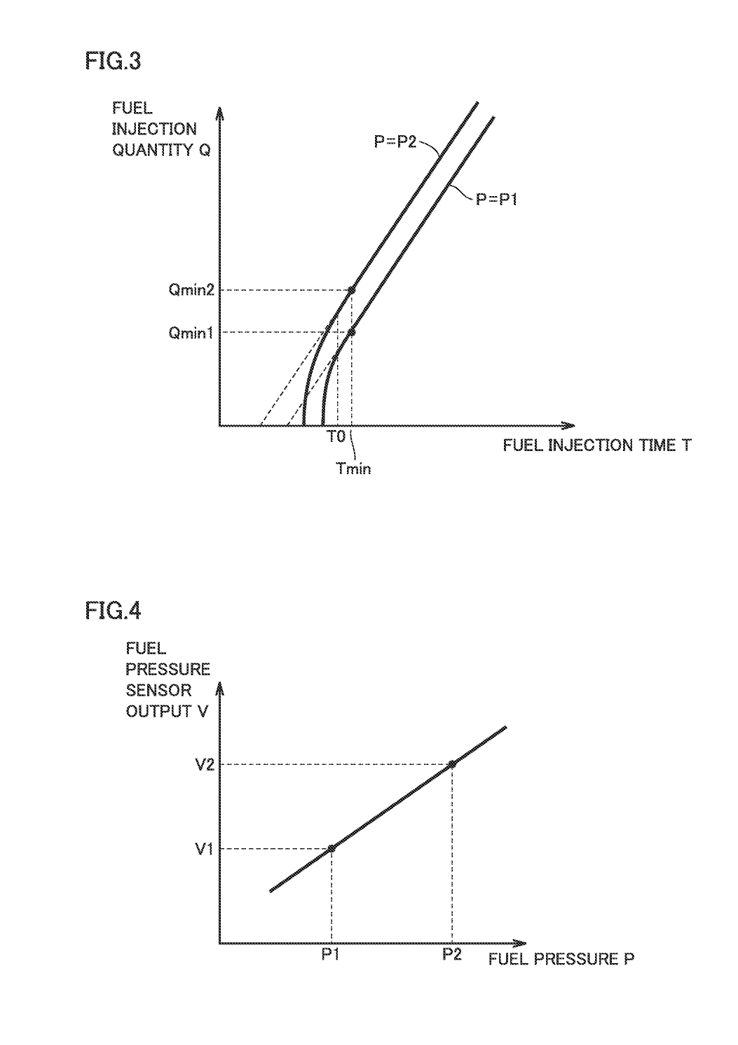

FIG. 3 is a diagram showing injection characteristics of port injection valve 54. In FIG. 3, the horizontal axis represents injection time T (the time for which the valve is opened) of port injection valve 54, and the vertical axis represents fuel injection quantity Q of port injection valve 54. In the following, the pressure of fuel in low-pressure delivery pipe 53 that has been compressed by feed pump 512 is referred to as “fuel pressure P.”

Fuel injection quantity Q of port injection valve 54 is basically proportional to the product of fuel pressure P and injection time T. Therefore, with respect to constant fuel pressure P, fuel injection quantity Q linearly increases with injection time T. This is a characteristic (linear controllability for fuel injection quantity Q) of port injection valve 54.

However, port injection valve 54 is a needle valve which is opened upon being energized, and the above-described linear controllability for fuel injection quantity Q is lost when the injection time T (energization time) is considerably short, specifically in the region less than a predetermined value T0. In view of this, in the present embodiment, the control range of injection time T is limited to the range from a minimum injection time Tmin which is slightly longer than predetermined value T0. Accordingly, the linear controllability for fuel injection quantity Q is ensured, and injection time T (energization time) can be controlled to thereby precisely control fuel injection quantity Q.

Due to the influence of the fact that the control range of injection time T is limited to at least minimum injection time Tmin, fuel injection quantity Q is also limited to at least minimum injection quantity Qmin which is determined based on fuel pressure P and minimum injection time Tmin.

In the present embodiment, fuel pressure P may be switched between a normal control pressure P1 which is used during normal control (a fault diagnosis of low-pressure fuel pressure sensor 53a is not conducted), and a diagnosis pressure P2 (>P1) which is used during a fault diagnosis of low-pressure fuel pressure sensor 53a, as will be described later herein. With respect to injection time T kept constant at minimum injection time Tmin, the higher the fuel pressure P, the larger the fuel injection quantity Q. Therefore, as shown in FIG. 3, relative to a minimum fuel injection quantity (hereinafter “minimum injection quantity Qmin1”) when fuel pressure P is normal control pressure P1, a minimum fuel injection quantity (hereinafter “minimum injection quantity Qmin2”) when fuel pressure P is diagnosis pressure P2 is larger.

[Fault Diagnosis of Low-Pressure Fuel Pressure Sensor 53a]

In order to variably control the supply pressure of fuel (fuel pressure P) generated by feed pump 512, it is necessary to ensure the reliability of the value detected by low-pressure fuel pressure sensor 53a mounted on low-pressure delivery pipe 53 storing fuel for port injection.

For this sake, engine ECU 141 in the present embodiment regularly conducts a fault diagnosis of low-pressure fuel pressure sensor 53a. For the fault diagnosis of low-pressure fuel pressure sensor 53a, engine ECU 141 increases fuel pressure P to diagnosis pressure P2 corresponding to the valve-opening pressure of relief valve 515. Based on whether or not low-pressure fuel pressure sensor 53a detects, at this time, a value representing the valve-opening pressure, engine ECU 141 determines whether or not low-pressure fuel pressure sensor 53a has a fault.

FIG. 4 is a diagram showing a correlation between fuel pressure P [unit: kPa] and output voltage V [unit: V (volt)] of low-pressure fuel pressure sensor 53a in the case where low-pressure fuel pressure sensor 53a is in a normal condition. As shown in FIG. 4, in the case where low-pressure fuel pressure sensor 53a is in a normal condition, the higher the fuel pressure P, the higher the output voltage V of low-pressure fuel pressure sensor 53a.

During normal control (in the case where a fault diagnosis of low-pressure fuel pressure sensor 53a is not conducted), engine ECU 141 controls feed pump 512 so that fuel pressure P is normal control pressure P1 (400 kPa for example). At this time, if low-pressure fuel pressure sensor 53a is in a normal condition, output voltage V of low-pressure fuel pressure sensor 53a is a value representing voltage V1 corresponding to normal control pressure P1.

In contrast, in the case where a fault diagnosis of low-pressure fuel pressure sensor 53a is to be conducted, engine ECU 141 performs control for increasing fuel pressure P to diagnosis pressure P2 (650 kPa for example) which is higher than normal control pressure P1, by increasing the output of feed pump 512 (this control is hereinafter also referred to as “fuel pressure increasing process”). Specifically, engine ECU 141 performs feed-forward control on feed pump 512 so that fuel pressure P becomes diagnosis pressure P2. Diagnosis pressure P2 is a fuel pressure corresponding to the valve opening pressure of relief valve 515.

If low-pressure fuel pressure sensor 53a is in a normal condition during the fuel pressure increasing process, output voltage V of low-pressure fuel pressure sensor 53a is a value representing voltage V2 corresponding to diagnosis pressure P2. Thus, based on whether or not the value detected by low-pressure fuel pressure sensor 53a during the fuel pressure increasing process is a value around voltage V2 which corresponds to diagnosis pressure P2, engine ECU 141 determines whether or not low-pressure fuel pressure sensor 53a has a fault.

[Engine Load Ratio Increasing Process during Fault Diagnosis]

As described above, in the case where a fault diagnosis of low-pressure fuel pressure sensor 53a is to be performed, engine ECU 141 performs the fuel pressure increasing process of increasing fuel pressure P to diagnosis pressure P2. However, the increase of fuel pressure P to diagnosis pressure P2 could cause fuel injection quantity Q to become larger than required, and accordingly deteriorate the emission performance

FIG. 5 is a diagram showing a relation between fuel pressure P, injection time T, and fuel injection quantity Q. With the horizontal axis representing fuel pressure P and the vertical axis representing injection time T, fuel injection quantity Q is proportional to the product of fuel pressure P and injection time T, and therefore, a curve for constant fuel injection quantity Q is represented by an inverse proportion curve as shown in FIG. 5.

In the case where the engine load ratio is low, the intake air quantity is accordingly small. Then, air-fuel ratio control (a process of performing feedback control for fuel injection quantity Q for making the air-fuel ratio equal to a target air-fuel ratio) is done to control fuel injection quantity Q so that fuel injection quantity Q is also small. In the example shown in FIG. 5, a case is shown where the engine load ratio is low and fuel injection quantity Q has a predetermined value Q0 which is relatively low. In order to cause fuel injection quantity Q to be predetermined value Q0 while fuel pressure P is normal control pressure P1, it is necessary that injection time T be time T1 (the point of intersection of the inverse proportion curve representing Q=Q0 and P=P1). Although this time T1 is a relatively short time, time T1 is slightly higher than minimum injection time Tmin. Thus, engine ECU 141 can set injection time T to time T1.

When fuel pressure P has been increased from normal control pressure P1 to diagnosis pressure P2, it is necessary, for making fuel injection quantity Q equal to predetermined value Q0, to set injection time T to time T2 (point of intersection of the inverse proportion curve representing Q=Q0 and P=P2) which is still shorter than time T1. However, this time T2 is shorter than minimum injection time Tmin, and thus injection time T must be set to minimum injection time Tmin which is longer than time T2. Consequently, fuel injection quantity Q becomes minimum injection quantity Qmin2 larger than predetermined value Q0 and therefore the fuel injection quantity Q becomes excessive with respect to the engine load ratio. Thus, the air-fuel ratio becomes a rich ratio and the emission performance is deteriorated.

In view of the above, in the case where the fuel injection quantity Q becomes excessive with respect to the engine load ratio during the fuel pressure increasing process, engine ECU 141 performs control so that the engine load ratio is increased (hereinafter referred to as “engine load ratio increasing process.”).

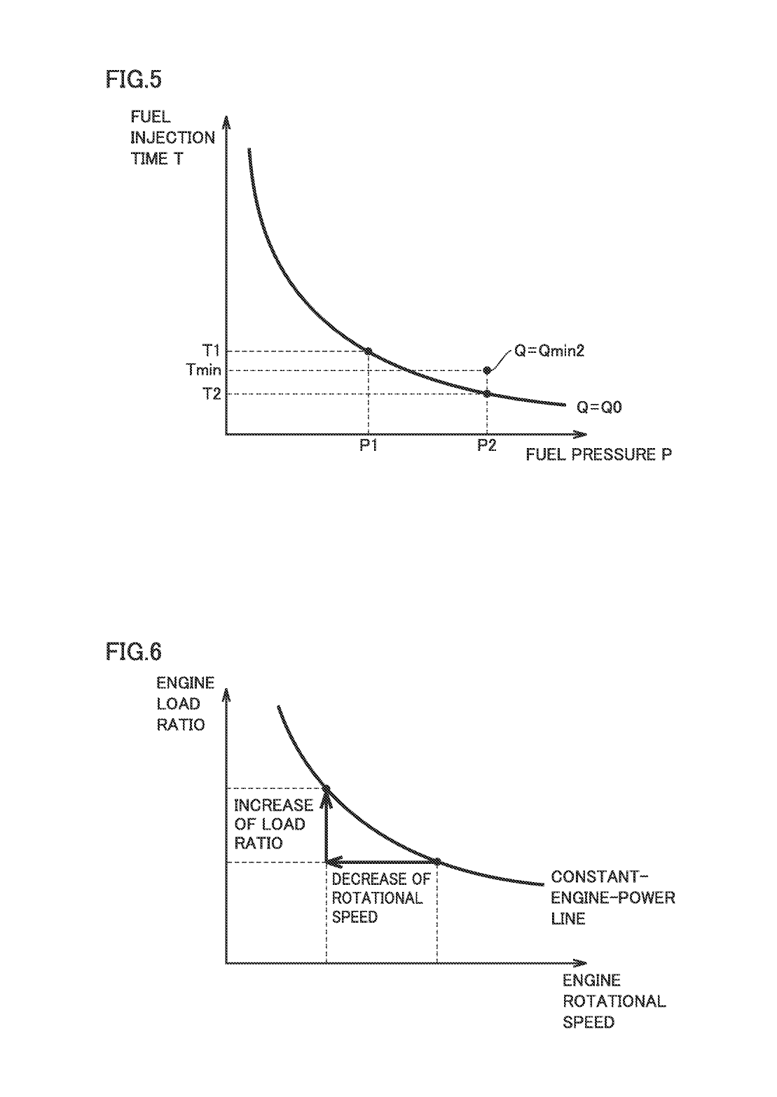

FIG. 6 is a diagram for illustrating details of the engine load ratio increasing process. As shown in FIG. 6, with the horizontal axis representing the engine rotational speed and the vertical axis representing the engine load ratio, the engine output is proportional to the product of the engine rotational speed and the engine load ratio, and therefore, a curve for a constant engine output (constant-engine-power curve) is represented by an inverse proportion curve as shown in FIG. 6.

On such a constant-engine-power curve, engine ECU 141 changes the engine operating point so that the engine rotational speed is decreased and thereby the engine load ratio is increased. Thus, the above-described “engine load ratio increasing process” is a process of changing the engine operating point so that the engine rotational speed is decreased while keeping the engine output as it is, and thereby the engine load ratio is increased, during a fault diagnosis of low-pressure fuel pressure sensor 53a. The engine load ratio increasing process which increases the engine load ratio causes the intake air quantity to increase and thus changes the air-fuel ratio to a leaner air-fuel ratio, and therefore, the air-fuel ratio is prevented from becoming a rich air-fuel ratio. Consequently, a fault diagnosis of low-pressure fuel pressure sensor 53a can be conducted without causing deterioration of the emission performance.

It should be noted that the present embodiment can decrease the engine rotational speed during the engine load ratio increasing process, by adjusting the rotational speed of motor generator 20.

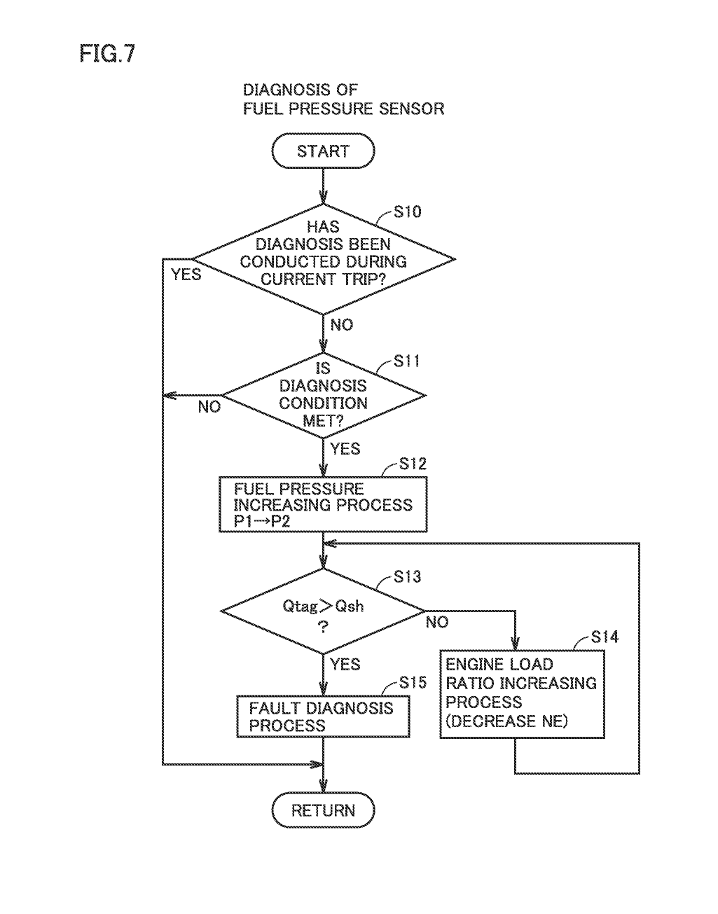

FIG. 7 is a flowchart showing a process procedure in the case where engine ECU 141 conducts a fault diagnosis of low-pressure fuel pressure sensor 53a. This flowchart is repeatedly followed at predetermined intervals while engine ECU 141 is operating.

In step (step is hereinafter abbreviated as “S”) 10, engine ECU 141 determines whether or not a fault diagnosis of low-pressure fuel pressure sensor 53a has already been conducted during the current trip. It should be noted that “trip” is a measure representing a single travel, and is typically a period from the time a user starts a vehicle system to the time the user thereafter stops the vehicle system.

In the case where a fault diagnosis of low-pressure fuel pressure sensor 53a has already been conducted during the current trip (YES in S10), engine ECU 141 directly ends the process without performing the subsequent operations in S11 to S15. In this way, the fault diagnosis of low-pressure fuel pressure sensor 53a is prevented from being conducted multiple times during one trip. Namely, the frequency at which the fault diagnosis of low-pressure fuel pressure sensor 53a is conducted is once per trip.

In the case where a fault diagnosis of low-pressure fuel pressure sensor 53a has not yet been conducted during the current trip (NO in S10), engine ECU 141 determines in S11 whether or not a diagnosis condition is met. This determination is made for the purpose of determining whether or not the current situation is appropriate for the fault diagnosis of low-pressure fuel pressure sensor 53a. For example, in the case of a highland for example where the atmospheric pressure is lower than a predetermined value, engine ECU 141 determines that the diagnosis condition is not met because it is expected that an accurate result cannot be derived from the diagnosis. In the case where the diagnosis condition is not met (NO in S11), engine ECU 141 directly ends the process without performing the subsequent operations in S12 to S15.

In the case where the diagnosis condition is met (YES in S11), engine ECU 141 performs in S12 the above-described fuel-pressure increasing process. Specifically, engine ECU 141 performs feed-forward control on feed pump 512 so that fuel pressure P is increased from normal control pressure P1 to diagnosis pressure P2.

In S13, it is determined whether or not a target fuel injection quantity Qtag is larger than a threshold value Qsh. This determination is made for the purpose of determining whether or not the fuel pressure increasing process in S12 causes the fuel to become excessive due to the increase of fuel pressure P to diagnosis pressure P2. In the present embodiment, target fuel injection quantity Qtag is a fuel injection quantity necessary for achieving the target air-fuel ratio with the current throttle opening (intake air quantity) as it is. Namely, target fuel injection quantity Qtag is a value determined by using the intake air quantity and the target air-fuel ratio. Threshold value Qsh is a fuel injection quantity (namely minimum injection quantity Qmin) which is obtained when fuel pressure P is diagnosis pressure P2 and injection time T is minimum injection time Tmin (see FIG. 3).

In the case where target fuel injection quantity Qtag is less than threshold value Qsh, it is necessary, in order to achieve the target air-fuel ratio, that injection time T be less than minimum injection time Tmin. Actually, however, injection time T can only be decreased to minimum injection time Tmin, and therefore, actual fuel injection quantity Q is larger than target fuel injection quantity Qtag.

In view of the above, in the case where target fuel injection quantity Qtag is smaller than threshold value Qsh (NO in S13), engine ECU 141 performs in S14 the above-described engine load ratio increasing process. Specifically, engine ECU 141 changes the engine operating point so that the engine rotational speed is decreased by a predetermined value while keeping the engine output as it is (on the constant-engine-power curve), and thereby the engine load ratio is increased by a predetermined value (see FIG. 6). The engine load ratio increasing process increases the engine load ratio and accordingly increases the intake air quantity, and therefore, target fuel injection quantity Qtag is also increased.

The increase of the engine load ratio (increase of target fuel injection quantity Qtag) by the engine load ratio increasing process is continued until target fuel injection quantity Qtag becomes larger than threshold value Qsh (namely until injection time T becomes longer than minimum injection time Tmin) Accordingly, the condition where the fuel is excessive is reliably prevented.

In the case where the engine load ratio increasing process causes target fuel injection quantity Qtag to become larger than threshold value Qsh (YES in S13), engine ECU 141 performs a fault diagnosis process for low-pressure fuel pressure sensor 53a. In this fault diagnosis process, engine ECU 141 determines, in the case where the output of low-pressure fuel pressure sensor 53a is a value representing voltage V2 which corresponds to diagnosis pressure P2, low-pressure fuel pressure sensor 53a is in a normal condition. Otherwise, engine ECU 141 determines that low-pressure fuel pressure sensor 53a has a fault.

As seen from the foregoing, in the case where engine ECU 141 in the present embodiment conducts a fault diagnosis of low-pressure fuel pressure sensor 53a, engine ECU 141 increases fuel pressure P to diagnosis pressure P2. However, in the case where the increase of fuel pressure P to diagnosis pressure P2 causes fuel to become excessive (rich air-fuel ratio), engine ECU 141 changes the engine operating point so that the engine rotational speed is decreased while keeping the engine output as it is, and thereby the engine load ratio is increased. Accordingly, with the engine output kept as it is, the intake air quantity can be increased to suppress the state where the fuel is excessive. As a result, the fault diagnosis of the fuel pressure sensor can be conducted without deteriorating the emission performance.

Regarding the above-described embodiment, the above description is given of the case where the engine load ratio increasing process in S14 is performed after the fuel-pressure increasing process in S12 is performed. However, the engine load ratio increasing process may be performed before the fuel pressure increasing process is performed. Namely, before the fuel pressure increasing process is performed, it may be predicted whether or not the fuel pressure increasing process will cause target fuel injection quantity Qtag to become smaller than threshold value Qsh. Then, in the case where it is predicted that the fuel pressure increasing process will cause target fuel injection quantity Qtag to become smaller than threshold value Qsh, the engine load ratio increasing process may be performed in advance and thereafter the fuel pressure increasing process may be performed.

Although particular embodiments have been described and illustrated in detail, it is clearly understood that the same is by way of illustration and example only and is not to be taken by way of limitation, the scope of the claimed subject matter.

What is claimed is:

1. A vehicle comprising:
an engine;
a fuel pump;
an injection valve configured to inject fuel supplied from the fuel pump to the engine;
a fuel pressure sensor configured to detect a supply pressure of the fuel generated by the fuel pump; and
a control apparatus configured to perform a fuel pressure increasing process of increasing the supply pressure of the fuel generated by the fuel pump to a second fuel pressure higher than a first fuel pressure, and conduct a fault diagnosis of the fuel pressure sensor based on a value detected by the fuel pressure sensor during the fuel pressure increasing process,
in a case where a fuel injection quantity of the injection valve becomes excessive with respect to a load ratio of the engine during the fuel pressure increasing process, the control apparatus configured to perform a load ratio increasing process of changing an operating point of the engine so that the load ratio of the engine increases.

2. The vehicle according to claim 1, wherein the load ratio increasing process is a process of increasing the load ratio of the engine by decreasing a rotational speed of the engine while keeping an output of the engine as it is.

3. The vehicle according to claim 1, wherein
the fuel injection quantity of the injection valve is proportional to a product of the supply pressure of the fuel generated by the fuel pump and an injection time of the injection valve,
a control range of the injection time of the injection valve is limited to a minimum injection time or more, and
in a case where a target fuel injection quantity determined by an intake air quantity and a target air-fuel ratio is less than a minimum injection quantity determined by the second fuel pressure and the minimum injection time, the control apparatus determines that the fuel injection quantity of the injection valve is excessive with respect to the load ratio of the engine and performs the load ratio increasing process.

4. The vehicle according to claim 3, wherein the control apparatus continues the load ratio increasing process until the target fuel injection quantity becomes larger than the minimum injection quantity.

5. The vehicle according to claim 1, wherein
the first fuel pressure is a control fuel pressure used when a fault diagnosis of the fuel pressure sensor is not conducted, and
the second fuel pressure is a diagnosis fuel pressure used when the fault diagnosis of the fuel pressure sensor is conducted.

6. The vehicle according to claim 1, wherein the injection valve is a port injection valve injecting fuel to an intake passage of the engine.
